(19) United States
(12) Patent Application Publication
(10) Pub. No.: US 2004/0225521 A1
(43) Pub. Date: Nov. 11, 2004

(54) Database system and method for managing labor costs against indicators

(76) Inventors: Jose Acosta, Scarsdale, NY (US); Paul West, New York, NY (US)

Correspondence Address: DARBY & DARBY P.C., P. O. BOX 5257, NEW YORK, NY, 10150-5257, US

(21) Appl. No.: 10/765,706

(22) Filed: Jan. 26, 2004

Related U.S. Application Data
(60) Provisional application No. 60/442,196, filed on Jan. 24, 2003.

(51) Int. Cl. G06F 17/60

(52) U.S. Cl. 705/1

(57) ABSTRACT

Employee shift data analysis method and system. Time records and corresponding labor codes are received concerning one or more employees. That data, along with actual revenue and expenses data, is held in a database and is correlated and compared with a budgeted entry in that database. Further comparisons can take place with respect to historical data that is compiled by the system based upon information gathered through the use of the system. The labor code preferably serves as the identifier for determining which entries should be compared. The display occurs through a conventional computer monitor or a printout of the report, both either locally or remotely.

This application claims the benefit of priority under 35 U.S.C. § 119 from U.S. Provisional Application 60/442,196, filed Jan. 24, 2003, titled “SYSTEM AND METHOD FOR EMPLOYEE SHIFT DATA-CAPTURE AND MANAGEMENT,” the entirety of which is hereby incorporated by reference.

### FIELD OF THE INVENTION

The present invention relates to the field of labor management, revenue reporting and reporting of operational revenue and labor data and, in particular, to a computerized database reporting system capable of incorporating business revenue records, along with personnel and management time records for purposes of generating analyses of such operations for past, current and future time periods and comparing such labor information against corresponding revenues and indicators and generate future labor information based on historical data.

### BACKGROUND OF THE INVENTION

Presently, businesses and industries utilize many different methodologies for generating and analyzing financial components of their particular business. Of significant importance to many of businesses are the data concerning personnel and overall cost of running their particular business units. Typically, businesses use a variety of spreadsheet programs to track data relating to business revenues and operating costs such as payroll. The data is then analyzed to determine the operations of the business over a specified period of time, specifically how the overall business operates in relation to past, budgeted and future costs of the business.

A standard developed by the hospitality industry, known as Full Time Equivalent (FTE), measures the number of employees based on hours worked. Full Time Equivalent is defined by calculating the number of hours worked divided by the number of workable hours in either one day or one month dependent, of course, on the methodology instituted by the particular business. An FTE value of one (1) illustrates that the particular individual or position being analyzed has worked the maximum workable hours for a given day, month or year and is, therefore, the optimal value to be achieved. However, to service the needs of a business, managers and decision makers may need to have additional staff on-hand or schedule overlapping labor shifts which impacts the value FTE.

Further, the hospitality industry measures labor expenses against the associated revenues to generate Key Performance Indicators (KPI), also known as Key Business Indicators (KBI). KPI or KBI are key measurements that indicate the efficiencies of a particular department or of the jobs in a particular department. KPI or KBI are determined by dividing the labor expenses of a particular job by the associated revenues or number of units (statistics) sold of that department. For certain departments that are not revenue producing departments, the KPIs or KBIs are measured by simply dividing the labor expenses against the revenues or statistics; thus, the KPI or KBI will be a percentage of the overall business revenues.

Businesses typically prepare labor and revenue reports with off-the-shelf spreadsheet software such as Excel, QuatroPro or Lotus, and then customize the spreadsheets to mirror the financial statements of that company. Although the time clock system provides data in the form of hours and wages, conventional systems are unable to compare this data to the business revenues and statistics, nor calculate the Key Performance Indicator or Key Business Indicator. Furthermore, existing time clock systems are unable to generate reports that monitor efficiency in the particular areas being analyzed. Most importantly, this option does not create a historical database of KPI or KBI, which can provide the data needed for providing forecasting and budgeting reports.

Therefore, what is needed and has not yet been satisfied is a method capable of importing actual employee hours worked and labor costs into a database which compares the working hours and labor costs with accumulated historical, forecasted and budgeted data wherein the database also generates reports to users for analysis of the data.

### SUMMARY OF THE INVENTION

According to one aspect of the present invention, a method is provided for analyzing employee data and utilizing said data for monitoring and projecting the overall efficiency of a particular business. Time records and corresponding labor codes associated with one or more employees who have particular positions in the business are received. That data is then held in a memory and then correlated and compared with an entry in a spreadsheet. The spreadsheet entry can be budgeted, forecasted or historical data. The labor code serves as the identifier for determining which entries should be compared. The comparison then yields varying types of statistics, such as FTE and wages efficiency (KPI or KBI), that are displayed to a user in report form. The display may occur through a conventional computer monitor or a printout of the report, both either locally or remotely.

Other aspects and features of the invention will be apparent from the following description of preferred embodiment and the accompanying drawing figures.

### BRIEF DESCRIPTION OF THE DRAWINGS

FIG. 1 illustrates an overview system diagram of one preferred embodiment of the invention;

FIG. 2 illustrates an overview flow chart detailing the interrelation between system and user;

FIGS. 3a-3d illustrate a browser interface useable with the embodiment of FIG. 1; and

FIGS. 4a-4d illustrate exemplary formats of reports generated by the embodiment of FIG. 1.

### DETAILED DESCRIPTION OF THE PREFERRED EMBODIMENT

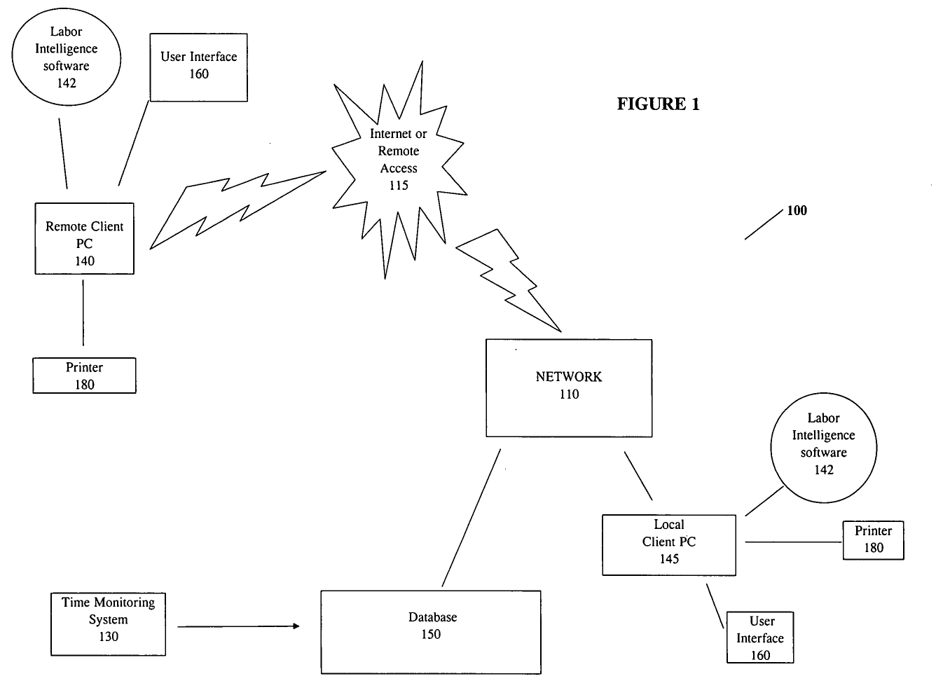

The present invention is directed to a system 100 and method for analyzing employee data such as hours and dollars, and other needs of a particular business. FIG. 1 illustrates an overview of an embodiment of the system 100 in which actual employee hours, dollars and labor codes can be imported into a database for comparison against historical data that is accumulated in this database and for further comparison against the forecast and budget data, if desired.

By way of overview and introduction, reports, provide information for the user to explore the possibilities of adjusting such labor expenses and analyzing business statistics, e.g., FTE, KPI, or KBI, prior to scheduling employees and expending future dollars. Analyzing these indicators are key for planning the future financial success of the business. Additional reporting provides the company with the cost of each position as compared to the overall revenues for a particular department, or the number of people served in a restaurant or the number of rooms sold in the hotel. Finally, a report automatically produces the daily revenue information for a hotel, restaurant, spa or fitness operation that provides all revenue streams for the operation based on information that is imported via spreadsheet or imported directly from a property management system. The aforementioned reports are exemplary correlations and presentations of the data entries, however, the invention is not limited to just these exemplary reports. Other correlations and presentation reports can be generated using this data, as is known by a person of ordinary skill in the art. An immediate advantage of the preferred embodiment is the savings per day incurred by the accounting personnel who usually produce such reports manually and can be completed in less time and with less effort.

Referring now to FIG. 1, the system 100 includes a network 110 and remote access server 115 for allowing the other components of the system 100, whether they are local or remote, to be in communication with one another. A time monitoring system 130, such as a conventional time clock or other subsystem that has data input (e.g., manual spreadsheets), allows for the gathering of employee time records. That time monitoring system 130 is electronically connected to a database 150. FIG. 1 shows the time monitoring system directly connected to database 150, but the time monitoring system can be also remotely connected to the database through remote access 115. For either connection, an interface controller (not shown) operates to control the transfer of data between the time monitoring system and the database.

The database in a basic implementation comprises an arrangement of data in the client pc 140, memory. In a more elaborate implementation data could be controlled by a managed software application with its own memory storage device and retrieval protocols. Both remote client pc 140 and local client pc 145 contain in memory the requisite labor intelligence software 142 for running the steps described below. The software 142 controls the derivations that take place with respect to the gathered data. The client pc 140, 145 is coupled to database 150 which stores, among other items, the data received from the time monitoring system 130. The database 150 can be coupled directly to a local client pc 145 and treated as a shared resource by the network 110, if desired. The data within the database 150 are uniform in that individual entries are assigned labor codes that may later be used for correlating current data with historical or budgeted data that is stored in a spreadsheet (not shown). The spreadsheet includes budgeted or projected data for hours, as well as varying types of revenue data, as is conventional. The data can be in the form of actual data, historical data—meaning past performance over a period of time set by the user (day, week, month, or year), forecast data—meaning a projected extrapolation of actual data, and budgeted data.

The system 100 further includes printers 180 and user interfaces 160. The user interfaces 160 provide users the ability to control the flow of data to the database 150, the frequency of derivations conducted upon the data, and the generation of reports. The reports that are generated are then either viewed on the client pc 140, 145 or in a paper form produced by the printer 180.

The operation of the system 100 will be described in conjunction with a preferred method for analyzing employee shift data.

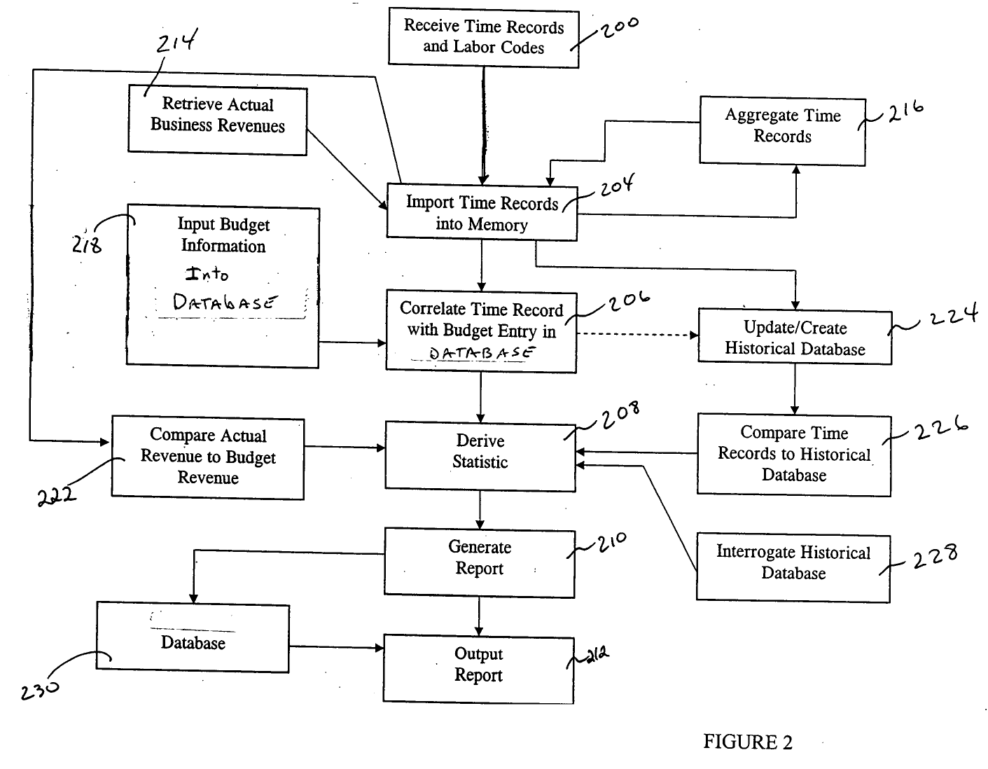

Referring to FIG. 2, a method is disclosed, in a flow chart format, for analyzing employee shift data and utilizing said data for monitoring and projecting the overall efficiency of a business. Initially, time records and labor codes are received (200) from one or more employees through a time monitoring system such as time monitoring system 130. The time monitoring system may be a conventional time clock, as is known, or any other electronically connectable means for monitoring hours worked by employees.

The labor codes mentioned above serve as identifiers for creating an association with a particular employee, department of the business, and/or particular positions in the business. The labor codes are preferably entered when the database is initially setup and can describe the business' employee hierarchy through a labor tree in complex business organizations. Such a labor tree can divide the business into division, department and specific job and also allow the association of labor codes with particular revenue, or unit count (statistics), for a department. Regardless of whether there is a labor tree, the labor codes identify fixed or permanent employees as well as variable employees. Variable employees are those employees that flexibly staff the business for random periods of time and whose existence is based upon the performance of, for example, a particular division.

The labor codes can also be used in conjunction with other information tally the number of employees working in a particular sector for purposes of drawing staffing reports. Those staffing reports are then used for determining whether a business is over or under staffed and whether the number of hours and dollars fall within the business indicators.

The labor tree setup is done in conjunction with assigning a key performance indicator to each labor code. The historical key performance indicators are set preferably when the system 100 is initially setup for a particular business or business unit. These key performance indicators are used with the labor code for determining whether a particular area of the business is performing its tasks efficiently, i.e., whether certain goals are being met. The key performance indicators used by particular businesses and divisions will vary significantly from one business or division to another.

The data received at step 200 is then imported into the client pc memory (step 204). The imported time records (204) are associated with particular labor codes and are compiled for that day and are preferably aggregated (216) on a routine basis with a frequency that can be set by the user through the interfaces 160. The step of aggregating the time records (216) allows continuous access to currently updated information and can be used for the steps of creating and updating a historical database (224), which preferably is stored at the database 150. Moreover, the actual business revenues earned from the business' operations are then retrieved from a machine connected to the network 110 or the client pc 140, 145 (214) and a budgeted amount for labor hours, dollars and revenues are imported into the database (218). Although the budgeted entries will vary for the particular businesses and departments within the businesses, they will nonetheless include such indicia as allotted workable hours associated with a particular labor code and maximum expenditures for a particular department or division of the business determined by the historical KPI or KBI

The next step involves correlating each imported time record and actual revenue produced with a budgeted entry in the spreadsheet (206). The database, as previously mentioned, contains imported budget information (218) for labor hours as well as labor expenses and revenues. Also as previously mentioned, the labor code serves as the identifier for correlating the budgeted information from the spreadsheet with the imported time records in the client pc memory. The entries are correlated by matching the labor codes assigned to the employee, task, department etc.

As correlation is completed, comparisons are then performed. One of the comparisons performed involves comparing between actual revenue received and budgeted labor expenses and revenues (222). The benefits of such a comparison are clear in that the bottom line dollar figures of the business operations can be regularly checked. Another comparison performed involves comparing the imported time records with those aggregated time records that make up the historical database. Still another comparison involves comparing the imported time entries with the budget hours and/or dollars. Those comparisons provide necessary information to business operators for determining staffing necessities in particular departments or divisions, and can further provide information on the efficiency of certain departments through the use of the revenue data.

Based upon these comparisons, varying types of statistics and revenues are derived (208) that are generated as a report (210) and displayed (212) to a user in the form of a report. The derivation step (208) preferably includes converting the previously mentioned comparisons into at least one efficiency value. Those efficiency values are used in some reports, as described below. The generating step (210) can automatically occur on a routine basis previously set by a user, or can be generated in response to a user request at the interface 160. Additionally, the generated reports are electronically transferred to the database 150 of the business (step 230). That database allows businesses to view the overall efficiency and production of different locations or divisions of the business since all will be contained within the database. Finally, the outputting of the report (212) may occur through a conventional computer monitor or through a printout of the report, operating through either local request at the local client pc 145, remotely at remote client pc 140 or a request received through the network 110 using conventional communication protocols.

The report generation and outputting steps (210, 212) serve to supplement the business with various efficiency values and indicia to provide a more complete view of the business' operations. One of the reports generated by the system 100 is a labor report. This report can be generated, like all of the reports generated by the system 100, in detail or summary format. The labor report summary format may be generated for a specific date or range of dates and will show the division and department for actual regular and overtime hours, actual regular and overtime wages, and will calculate the actual full-time-equivalent. This report, like all of the reports disclosed herein, compare the data to forecast, budget and compiled historical data. The detailed report version, like all of the other detailed report versions generated by the system 100, in addition to providing the information set forth in the summary report with respect to division and department, can show the labor codes, actual regular and overtime hours, actual regular and overtime wages, and can calculate the actual full-time-equivalent associated with those labor codes. The remaining reports will be described herein as detail/summary reports with the understanding that the detail version of the reports adds the feature concerning the labor codes.

As previously noted, variable employees, unlike fixed employees, are put on staff for a particular event or limited time period and will exist based upon performance of their sectors. Those variable employees require analysis within the business, as do the fixed employees. Accordingly, a fixed/variable detail/summary hours report can be generated for a specific date or range of dates and will show the division, department and labor codes associated with the actual fixed and variable hours as compared to forecast, budget and historical. Moreover, a fixed/variable detail/summary FTE's report may be generated for a specific date or range of dates and will show the division, department and labor codes' actual fixed and variable FTE's, again compared to forecast, budget and historical data. Finally, a fixed/variable detail/summary wages report may be generated for a specific date or range of dates and will show the division, department, and labor codes actual fixed and variable wages, also compared to forecast, budget and prior year.

Other reports can include an average key performance indicator that summarizes the key performance statistics that were defined in the database when the labor code was set up, by division, department and position compared to forecast, budget and/or historical data. A labor forecast report generates a detailed forecast of labor costs and hours by labor code for a specified range of dates based on historical KPI or KBI. Revenue reports can be generated for a specific date or range of dates to show the actual revenues and statistics by department as compared to forecast, budget and historical data. Staffing guide reports can show the predetermined staffing levels established during the set-up process as compared to the actual full time equivalent employees (FTE); this report shows the comparison of employee count and the average wage paid for all the labor codes within the system 100.

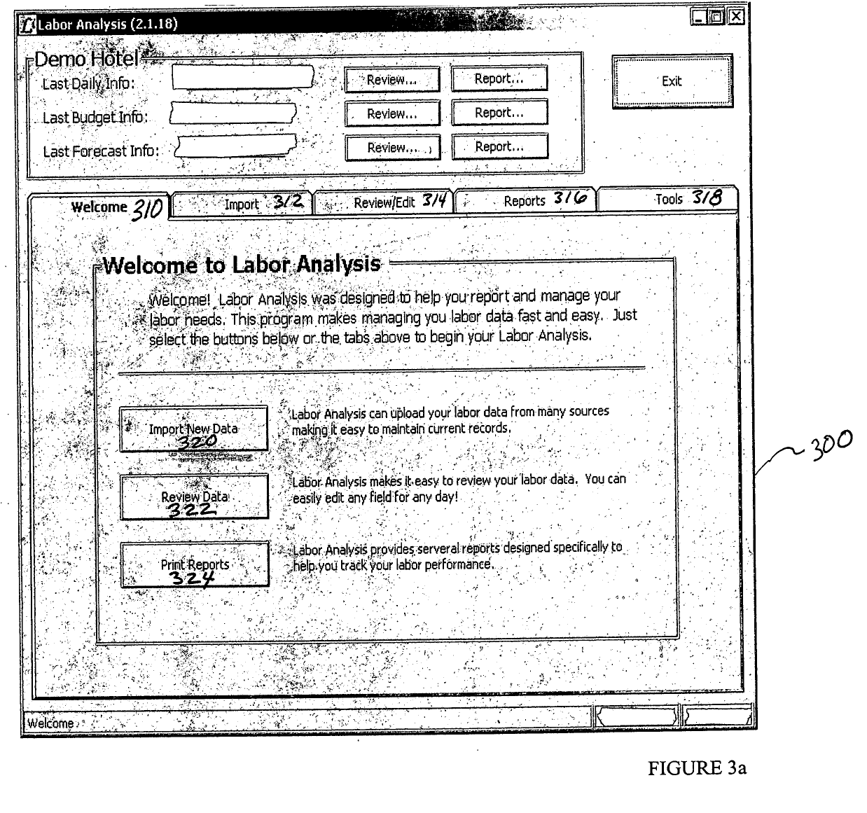

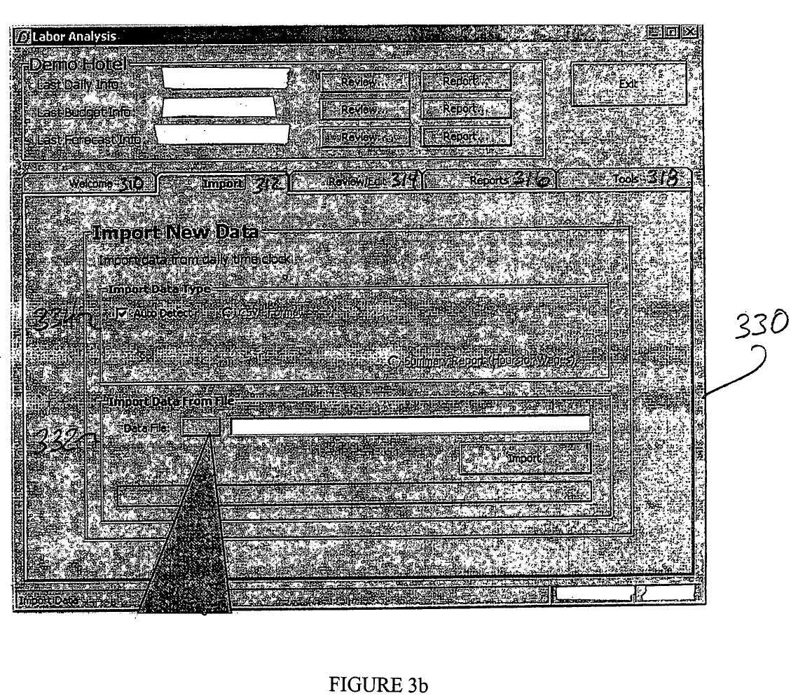

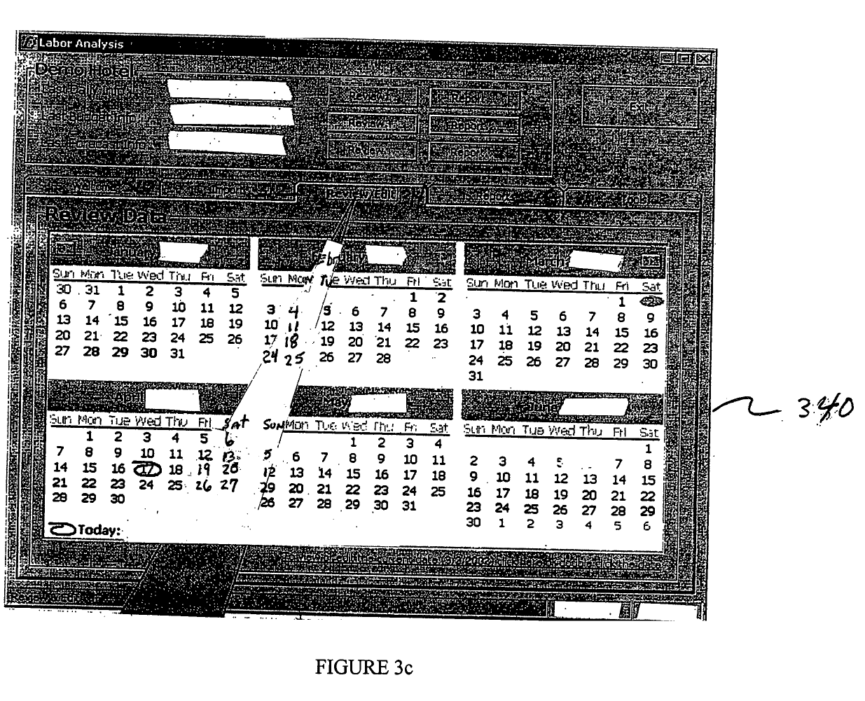

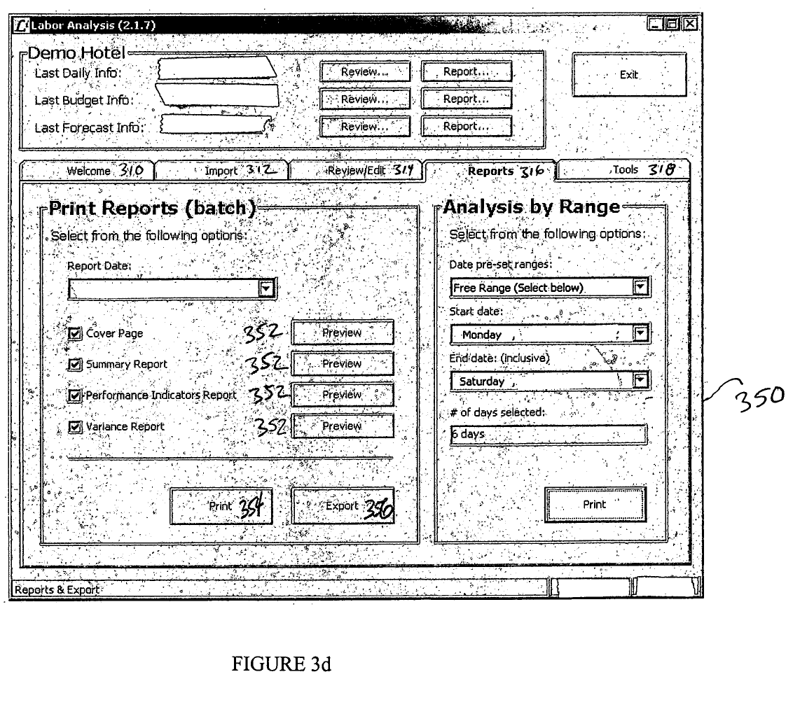

FIG. 3a illustrates a browser interface 300 through which a user can operate the system 100. The browser interface has active buttons 320, 322, 324 and tabs 310, 312,314, 316, 318 that provide a user with access to the various functions of the system. The Welcome tab 310 provides descriptions and access to the system 100 functions available to the user, and is illustrated as the active pane in FIG. 3a.

Selection of the Import New Data button 320 (or tab 312) provides the user with a GUI screen as illustrated in FIG. 3b. The Import New Data screen 330 contains a data entry field 332 which allows a user to identify to the system 100 the source of the new data. Screen 330 also contains a checkbox 334 to identify the data format or set an auto detect mode. New data representing a summary of daily hours and wages, or more detailed information for a single day or multiple days, can be imported directly from an automated time clock system with data transfer capabilities or from a text file. The system 100 parses the imported data and stores the results in the database 150. The Review Data button 322 (depicted in FIG. 3a), or tab 312, provides the users with the ability to review and edit the daily labor data after it is imported.

Selection of the Review/Edit tab 314 (or button 322) changes the display and presents a GUI display in the form of a calendar 340, as exemplary depicted in FIG. 3c. The calendar 340 is an active interface that presents the imported data and permits a user to select data to be reviewed—e.g., on a daily, weekly, monthly, or etc. basis. A user can determine which dates have already been imported, and for which dates data is needed.

Selection of the Reports tab 316 (or button 324) presents a Report Generation 350 GUI display, which assists a user in selection of data and formatting reports. A user can select the report date and print multiple reports based on the selected date. Preview buttons 352 are provided so that a user can preview a report prior to its being printed. Print button 354 causes the selected report to be printed; alternatively a user can have the report printed from the preview screen.

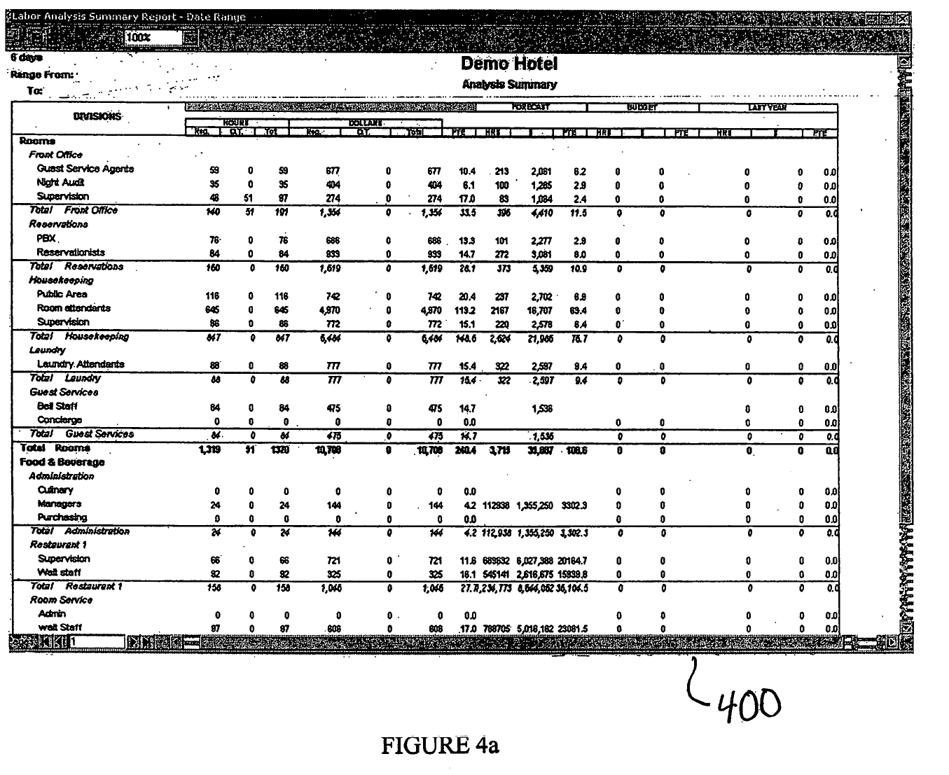

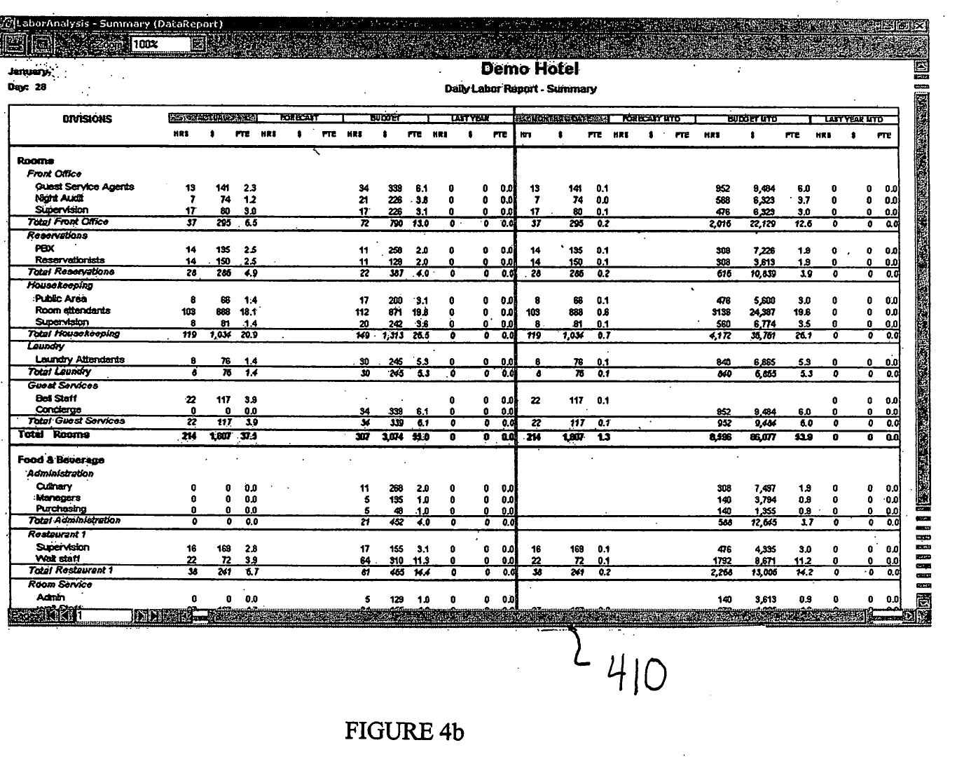

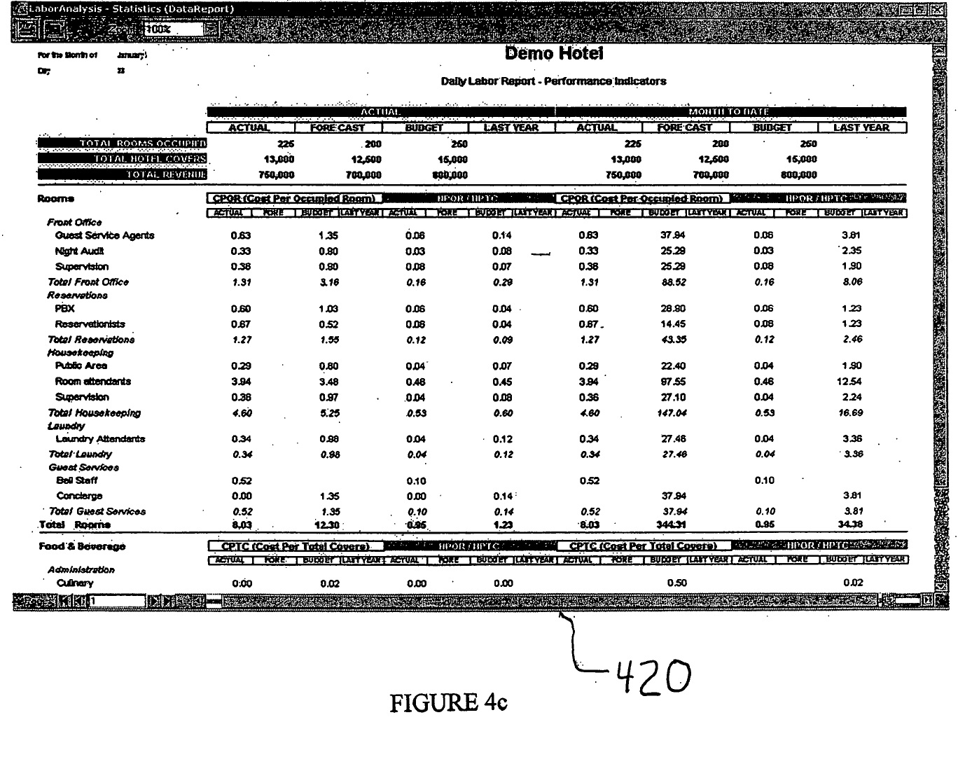

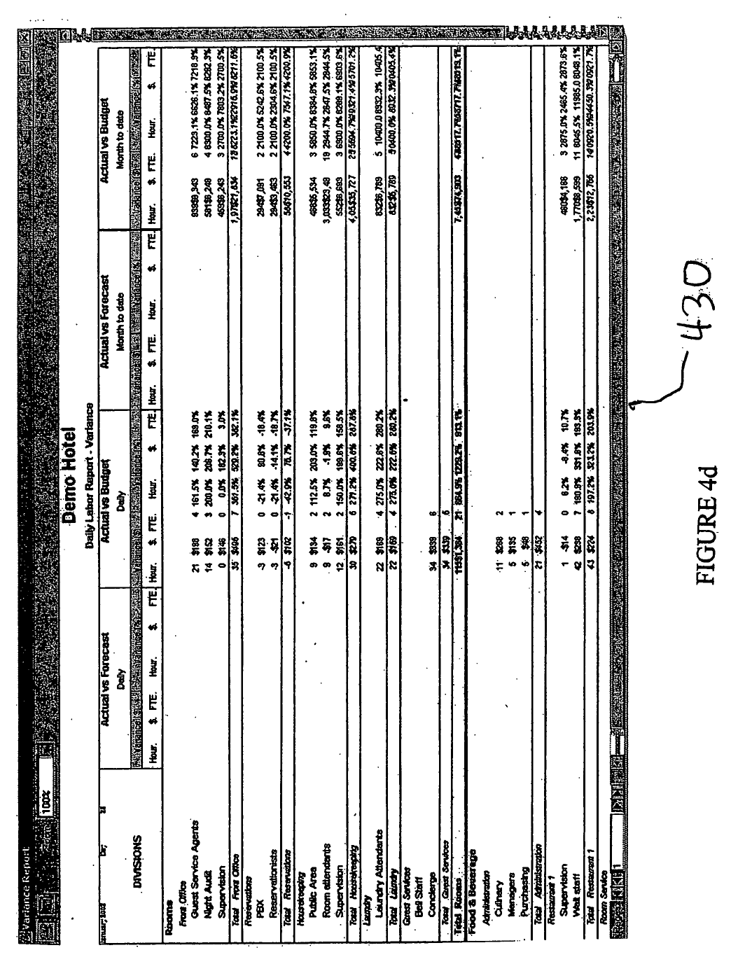

FIGS. 4a-4d illustrate exemplary formats for reports generated by system 100. Selection of Export button 356 exports the selected report data in formats that include HTML and text.

FIG. 4a depicts an exemplary format for an Analysis Summary display screen 400 for an embodiment of the invention. The Analysis Summary display screen presents the actual, forecast, budgeted, and prior year data for divisions (e.g., “Rooms” and “Food & Beverage”) broken down by category (e.g., “Front Office,” “Reservations,” “Laundry,” etc.) and further presented by labor code. The hours of regular time and over-time worked and the corresponding dollar cost are made available to the user, along with the statistical FTE equivalent of the data. Column totals for each labor code are displayed by category, and totals for each division are also provided. Similarly, FIG. 4b depicts an exemplary format for a Daily Labor Report Summary display screen 410, which provides a daily report of similar information and statistics.

The summary reports 400, 410 present information so that a user can compare actual labor costs and overtime expenses against forecast, budget and prior year amounts with entrees sorted by labor codes (e.g., the category “Guest Services” includes two labor codes, one for “Bell Staff” and another for “Concierge”). The system 100 also calculates the FTE and includes it in the summary reports 400, 410.

The system 100 can prepare Performance Indicator reports 420, such as depicted in FIG. 4c, which present analysis of the labor cost against a performance indicator that is selected by the user. As an example, the labor cost can be presented as the cost per rooms occupied. The report also compares performance to other indicators, such as the actual, forecasted, budgeted, and prior year data for the total rooms occupied, total hotel covers, and total revenue. Additionally, system 100 can prepare Variance reports 430 as one type of statistic, as illustrated in FIG. 4d, which present the differences between actual labor costs and forecast or budgeted values. The time period for the Variance report can be selected by the user. The variances can be displayed in hours, dollars, and FTE. The Variance report can be prepared automatically by the system 100 using preset instructions entered by the user.

All of the reports previously mentioned can be generated as a value and percentage variance report or in graph format. Additionally, the reports can be printed by selected division, department and labor codes to pinpoint any problem or beneficial areas of the business. The reports can be displayed via e-mail or onto a server for departmental distribution and therefore allows corporate or regional managers to view, analyze and print reports for multiple properties. Finally, the report generation by the system can take place entirely on the web using only a web browser to access the system on a server.

The preferred embodiment removes a weak link created by the common use of manual, inefficient and error-prone spreadsheets. The system of the preferred embodiment assesses and revises labor requirements on, for example, a daily, weekly, monthly and yearly basis to provide hotel operators, other similar hospitality operators, and other businesses with the information needed to manage labor forces and reduce costs. This system further provides users with the ability to review historical labor information, to forecast future labor expenses and hours based upon historical performance. Awareness is created by allowing management to properly determine how labor costs compare to forecast budget and prior years on any given day of the month.

While the invention has been particularly shown and described with reference to preferred embodiments thereof, it will be understood by those skilled in the art that various changes in form and details may be made therein without departing from the spirit and scope of the invention.

We claim:

1. A method for analyzing labor efficiencies comprising the steps of:
receiving time records and corresponding labor codes associated with one or more employees;
importing the received time records for the one or more employees from a time monitoring system into a database;
correlating each imported time record to a prescribed entry in a spreadsheet using the labor code;
wherein the prescribed entry is one of budgeted, forecasted, and historical data;
comparing each entry in the spreadsheet to the correlated time record in the database;
deriving a statistic based on the comparison;
generating a report of the statistic; and
outputting the report to a user.

2. The method as in claim 1, wherein the importing step includes the steps of retrieving actual revenues earned for a business and inputting a budget for hours and revenues, and wherein the deriving step includes deriving the statistic with regard to at least one of the actual revenues and the budget.

3. The method as in claim 1, wherein entries in the spreadsheet represent allotted workable hours for each labor code.

4. The method as in claim 1, wherein entries in the spreadsheet represent allotted expenditures.

5. The method as in claim 1, wherein the received time records of each employee are aggregated in the database on at least one of a daily, weekly, monthly and yearly basis.

6. The method as in claim 5, wherein the aggregated time records in the database define a historical database.

7. The method as in claim 6, wherein the step of comparing includes comparing the time records to the historical database.

8. The method as in claim 2, wherein the step of comparing includes comparing actual revenues generated by the business to the budget.

9. The method as in claim 2, wherein the step of comparing includes comparing the time entries with the hours budget.

10. The method as in claim 2, wherein the time monitoring system comprises one or more time clocks electronically connected to the database.

11. The method as in claim 1, wherein the deriving step includes converting the comparison into at least one efficiency value.

12. The method as in claim 1, wherein the generating step occurs automatically.

13. The method as in claim 1, wherein the generating step is accomplished in response to a user request.

14. The method as in claim 12, wherein the report is electronically transferred to a database.

15. The method as in claim 13, wherein the report is electronically transferred to a database.

16. The method as in claim 1, further comprising the steps of:
importing revenue records of one or more departments of a particular business unit into the database;
wherein the deriving step further comprises deriving a second statistic based on comparing the statistic with revenue; and
wherein the generating step further comprises generating a report of at least the statistic and revenue.

17. The method as in claim 1, further comprising the steps of:
correlating the received time records and the corresponding labor codes in a spreadsheet; and
correlating the received time records with a designated indicator.

18. A method for analyzing the performance of a business, comprising the steps of:
receiving time records and corresponding labor codes associated with one or more employees;
grouping the labor codes such that the labor codes are associated with a department of the business;
importing the received time records and labor codes for the one or more employees from a time monitoring system into a database;
inputting a revenue generated by the business for each department into the memory;
correlating each imported time record to a prescribed entry in a first spreadsheet using the labor code groups;
wherein the prescribed entry is one of budgeted, forecasted, and historical data;
associating the department revenues with at least one prescribed revenue for the department in a second spreadsheet;
wherein the prescribed revenue is one of budgeted, forecasted, and historical revenue;
comparing each entry in the first spreadsheet to the correlated entry in the second spreadsheet;
deriving a statistic based on the comparison;
generating a report of the statistic; and
outputting the report to a user.

19. A system for analyzing labor efficiencies comprising:
at least one time monitoring system;
a database adapted to maintain a historical database based upon time records retrieved from the time monitoring system, budgeted data for time records and business expenditures, and further including means for comparing the time records with the historical database to generate a statistic;
a central processing unit communicatively coupled to the at least one time monitoring system so as to be able to process the time records and adapted to provide information to the database,
wherein the database is accessible by a user to output a report detailing the generated statistics.
